(19) United States
(12) Patent Application Publication
(10) Pub. No.: US 2012/0204833 A1
(43) Pub. Date: Aug. 16, 2012

(54) FUEL INJECTION DEVICE

(75) Inventors: Toshiyuki Yonemoto, Nagoya-city (JP); Katsumi Mori, Chiryu-city (JP); Hideki Narisako, Kariya-city (JP)

(73) Assignee: DENSO CORPORATION, Kariya-city (JP)

(21) Appl. No.: 13/369,515

(22) Filed: Feb. 9, 2012

(30) Foreign Application Priority Data
Feb. 10, 2011 (JP) 2011-27176

(51) Int. Cl. F02M 57/02

(52) U.S. Cl. 123/446

(57) ABSTRACT

A fuel injection device includes a fuel supply pump, an injector, a filter, a circulation flow passage, an introduction valve, a circulation flow valve and a check valve. The injector supplies fuel discharged from the fuel supply pump to an engine, and the filter is arranged upstream of the fuel supply pump. The circulation flow passage introduces high-pressure fuel into the filter from a high-pressure flow passage provided between the fuel supply pump and the injector by opening of the introduction valve. The circulation flow valve is provided in the circulation flow passage and allows or interrupts inflow of fuel from the circulation flow passage into the filter depending on a fuel temperature. The check valve is provided upstream of the circulation flow valve to prevent backflow, and opens when a fuel pressure in the circulation flow passage is higher than a predetermined pressure.

### CROSS REFERENCE TO RELATED APPLICATION

This application is based on and incorporates herein by reference Japanese Patent Application No. 2011-027176 filed on Feb. 10, 2011.

### TECHNICAL FIELD

The present description relates to a fuel injection device which injects fuel into an engine.

### BACKGROUND

Conventionally, a technology regarding a fuel injection device is disclosed, in which wax solidified due to reduction of fuel temperature is prevented from causing clogging in a filter (hereinafter, referred to as filter wax-clogging). For example, a return-fuel circulation method is provided (e.g., refer to JP 2005-098212A and EP 0819844A2), in which the wax is dissolved by introducing low-pressure fuel returned from an injector or the like. But, in this technology, it is a precondition that an amount of heat of the returned fuel is sufficient for dissolving the wax.

In a fuel injection device of recent years, a return amount of fuel from the injector is reduced for improvement of fuel efficiency, so that a pressure-feeding amount of fuel from a pump is reduced as much as possible, and an engine load is decreased. Hence, a temperature of the returned fuel reduces, and thus, it is difficult to dissolve the wax by the return-fuel circulating method.

Thus, as a method for dissolution of the filter wax-clogging, a part of high-pressure fuel supplied to the injector is introduced into the filter (refer to EP 1209349A2). However, a pressure of the fuel may decrease before the introduction of the fuel into the filter from the injector, and thereby it may be difficult to keep the temperature of the fuel high.

### SUMMARY

The present invention addresses at least one of the above disadvantages. According to an exemplar aspect of the present description, a fuel injection device includes a fuel supply pump, an injector, a filter, a circulation flow passage, an introduction valve, a circulation flow valve and a check valve. The fuel supply pump pressurizes and discharges fuel, and the injector injects and supplies fuel discharged from the fuel supply pump to an engine. The filter is arranged upstream of the fuel supply pump to remove foreign material contained in fuel. The circulation flow passage is configured to introduce high-pressure fuel into the filter from a high-pressure flow passage provided between the fuel supply pump and the injector. The introduction valve is configured to allow or interrupt inflow of high-pressure fuel from the high-pressure flow passage into the circulation flow passage. The circulation flow valve is provided in the circulation flow passage and is opened or closed depending on a temperature of fuel to allow or interrupt inflow of fuel from the circulation flow passage into the filter. The check valve is provided upstream of the circulation flow valve in the circulation flow passage to prevent backflow. The check valve opens when a pressure of fuel in the circulation flow passage is higher than a predetermined pressure. Accordingly, wax-clogging of the filter is able to be dissolved securely.

### BRIEF DESCRIPTION OF THE DRAWINGS

The invention, together with additional objectives, features and advantages thereof, will be best understood from the following description, the appended claims and the accompanying drawings in which:

FIG. 1 is a schematic diagram showing a fuel injection device according to an exemplar embodiment of the invention;

FIG. 2 is a schematic diagram showing a part of the fuel injection device according to the exemplar embodiment; and

FIG. 3 is a diagram for explanation of an operation of the fuel injection device according to the embodiment.

### DETAILED DESCRIPTION OF EMBODIMENTS

A fuel injection device of the present description includes a fuel supply pump, a common rail, an injector, and a filter. The fuel supply pump pressurizes and discharges fuel, and the common rail stores the fuel supplied from the fuel supply pump. The injector injects and supplies the fuel supplied from the common rail to an engine, and the filter is arranged upstream of the fuel supply pump to remove foreign material contained in the fuel.

The fuel injection device includes a circulation flow passage, an introduction valve, a circulation flow valve, and a check valve. The circulation flow passage is used for introducing high-pressure fuel into the filter from a high-pressure flow passage provided between the fuel supply pump and the injector. The introduction valve introduces high-pressure fuel into the circulation flow passage. The circulation flow valve is provided in the circulation flow passage to be opened or closed depending on a temperature of fuel to allow or interrupt inflow of the fuel from the circulation fuel passage into the filter. The check valve is provided upstream of the circulation flow valve in the circulation flow passage, to be open when a pressure of fuel is more than or equal to a predetermined pressure, and to prevent a backward flow.

A pressure control valve, which functions as a decompression valve of the common rail, is used as the introduction valve.

Details will be described in following embodiments.

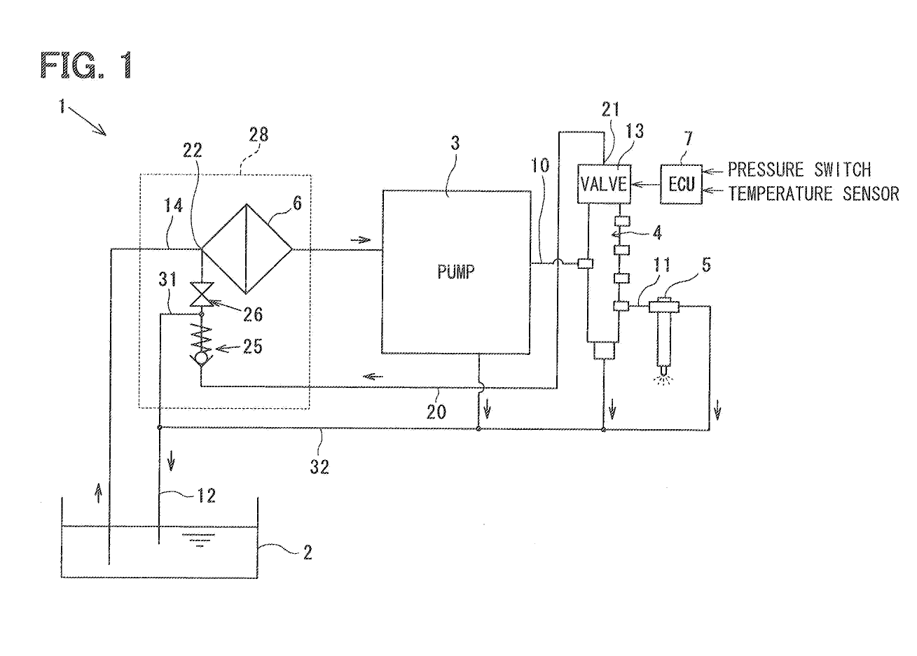

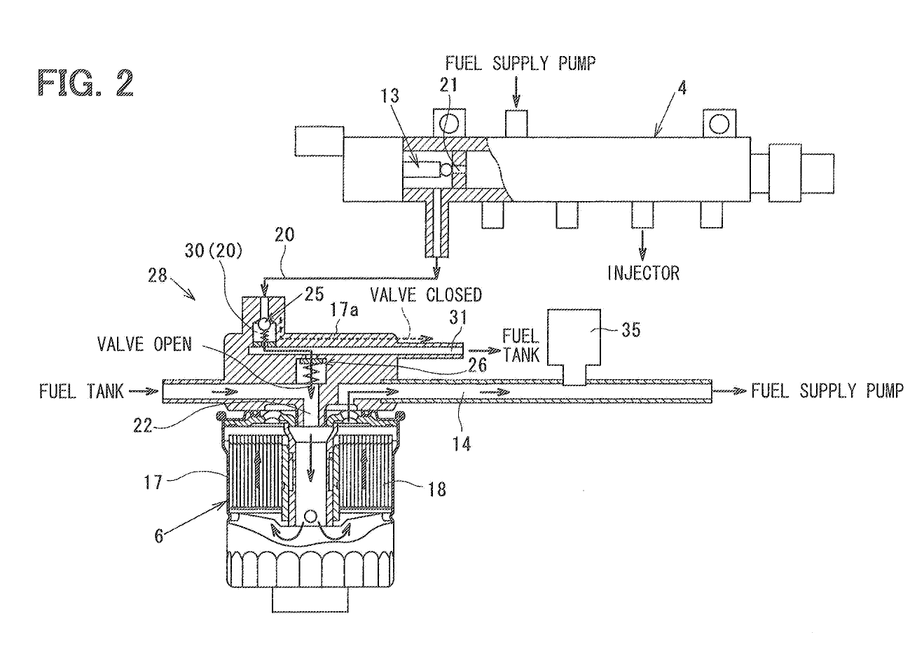

A fuel injection device 1 of an exemplar embodiment will be described referring to FIGS. 1 and 2.

For example, the fuel injection device 1 is configured to inject and supply fuel to a diesel engine (not shown, and hereinafter, referred to as an engine).

The fuel injection device 1 includes a fuel supply pump 3, a common rail 4, an injector 5, a filter 6, and an electronic control unit (ECU) 7. The fuel supply pump 3 draws fuel in a fuel tank 2, and pressurizes and discharges the fuel. The common rail 4 accumulates the fuel discharged from the fuel supply pump 3 in a high-pressure state. The injector 5 injects the fuel accumulated in the common rail 4 into a cylinder of the engine. The filter 6 is arranged upstream of the fuel supply pump 3 to remove foreign material contained in the fuel. The ECU 7 controls operations of the fuel supply pump 3, the injector 5, and the like.

The fuel supply pump 3 draws the fuel contained in the fuel tank 2, and pressurizes and discharges the fuel such that the fuel of the common rail 4 is accumulated at a target pressure (target rail pressure) depending on a state of the engine.

The common rail 4 is connected to a discharge port of the fuel supply pump 3 via a high-pressure pipe 10. The common rail 4 receives supply of pressurized fuel and accumulates the fuel in the high-pressure state. The common rail 4 is connected to an inlet of the injector 5 via a high-pressure pipe 11, and supplies fuel having an actual rail pressure to the injector 5. Thus, the common rail 4 functions as an accumulation holder which accumulates high-pressure fuel, and functions also as a distribution holder which distributes high-pressure fuel to the injector 5.

Moreover, a decompression valve 13 (pressure control valve) is attached to an end of the common rail 4. The decompression valve 13 is open to release the fuel in the common rail 4 to a low-pressure pipe 12, thereby decompressing the actual rail pressure. The decompression valve 13 is an electromagnetic valve, and its operation is controlled by a control portion described later.

The injector 5 is connected to the high-pressure pipe 11 and communicates with the common rail 4. The injector 5 includes an injection nozzle which injects fuel into the cylinder, and an electromagnetic valve which actuates the injection nozzle. The injector 5 is provided as many as the cylinders, although FIG. 1 shows a single one.

The filter 6 is arranged in a fuel suction flow passage 14 through which the fuel tank 2 and a suction port of the fuel supply pump 3 are connected to each other. The filter 6 removes water and solid material such as dust, which are contained in the fuel, and has a generally known structure. Thus, the filter 6 includes a filter element 18, which is made of, for example, a filter paper, in a filter case 17. By using the filter element 18, dust or the like in fuel is caught. When the fuel is low in temperature, wax which is a solidified fuel may adhere to the filter element 18.

The ECU 7 is a computer having a generally known structure, which includes a central processing unit (CPU), a storage unit, an input circuit and an output circuit. The CPU performs a control processing and an arithmetic processing. The storage unit, such as a read-only memory (ROM) and a random access memory (RAM), stores a variety of programs and data. The ECU 7 receives input of detection values from a variety of sensors, and then performs the arithmetic processing based on the detection values. Subsequently, the ECU 7 outputs command values to a variety of actuators (e.g., an electromagnetic actuator of the injector 5).

The fuel injection device 1 of the present exemplar embodiment has a circulation flow passage for introducing a part of high-pressure fuel into the filter 6 from a high-pressure flow passage provided between the fuel supply pump 3 and the injector 5. For example, a high-pressure pipe 20 is provided in the present embodiment, to introduce high-pressure fuel flowing out of the common rail 4 due to an opening of the decompression valve 13, to the filter 6. More specifically, a pressure release port 21 of the common rail 4, which is opened and closed by operation of the decompression valve 13, and an inlet 22 of the filter 6 are connected with each other through the high-pressure pipe 20. Therefore, the high-pressure pipe 20 is provided as an example of the circulation flow passage. The decompression valve 13 is used as an example of an introduction valve which introduces high-pressure fuel into the circulation flow passage.

A check valve 25 and a circulation flow valve 26 are arranged in the high-pressure pipe 20 in this order from an upstream side. The check valve 25 opens when a pressure of fuel is more than or equal to a predetermined pressure, and prevents a backward flow. For example, a spring check valve is adopted as the check valve 25. The circulation'flow valve 26 is a thermostatic valve, and is opened and closed due to a bimetal which deforms depending on a temperature. Thus, the circulation valve 26 allows or interrupts inflow of fuel from the circulation flow passage into the filter 6 in accordance with a temperature of fuel. Specifically, the circulation flow valve 26 is in a valve-closing state when the temperature of fuel is higher than a predetermined temperature. The circulation flow valve 26 opens when the temperature of fuel is equal to or lower than the predetermined temperature, and allows inflow of high-pressure fuel into the filter 6.

In the present embodiment, the circulation flow valve 26, the check valve 25, and the filter 6 are unitized to configure a filter unit 28, as shown in FIG. 2. Thus, the filter unit 28 includes a part of the high-pressure pipe 20, the circulation flow valve 26, the check valve 25, and the filter 6. For example, as shown in FIG. 2, a cap part 17a is attached to the filter case 17, and the cap part 17a is formed as a part (inside-unit high-pressure pipe 30) of the high-pressure pipe 20 to communicate with the inlet 22 of the filter 6.

A return pipe 31 is connected to the high-pressure pipe 20 at a position downstream of the check valve 25 and upstream of the circulation flow valve 26 in a fuel flow of the high-pressure pipe 20. The return pipe 31 communicates with the low-pressure pipe 12 through which fuel returns to the fuel tank 2. A return pipe 32 is also connected to the low-pressure pipe 12. The return pipe 32 is provided to return low-pressure fuel leaked from the fuel supply pump 3, the common rail 4 and the injector 5 to the fuel tank 2.

The ECU 7 is configured to include a determination portion, which determines whether the filter 6 is clogged with wax or not, based on a fuel pressure state around the filter 6 or in the filter 6 and based on a temperature state of the engine. The ECU 7 is also configured to include the control portion which commands the introduction valve (e.g., decompression valve 13) to introduce high-pressure fuel into the high-pressure pipe 20 when the filter wax-clogging is determined.

The filter wax-clogging occurs in a low temperature state where fuel is easy to be solidified. If the filter wax-clogging occurs, a suction pressure of the fuel supply pump 3 at a downstream side of the filter 6 increases. Thus, if the temperature state of the engine and the pressure state around the filter 6 are detected, the determination portion can determine whether the filter wax-clogging has occurred.

In the present exemplar embodiment, a pressure switch 35 is provided at a position downstream of the filter 6 in the fuel suction flow passage 14. A state of the pressure switch 35 becomes ON when the pump suction pressure at the downstream side of the filter 6 is higher than a predetermined value, and the state is output to the ECU 7. The temperature state of the engine is, for example, an outside air temperature Ta, and a detection value from an outside air sensor (not shown) is output to the ECU 7.

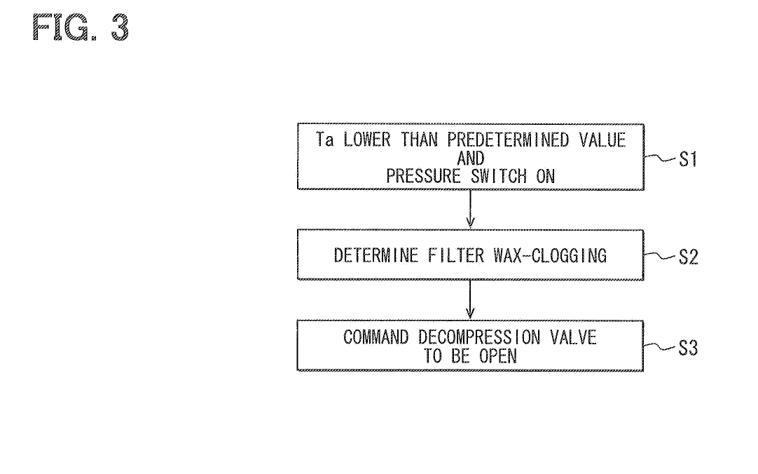

As shown in FIG. 3, when the outside air temperature Ta is lower than a predetermined value and when a signal from the pressure switch 35 is ON, the determination portion determines that the “filter wax-clogging” has occurred (S1, S2). When the outside air temperature Ta is higher than the predetermined value and when the signal from the pressure switch 35 is ON, it may be determined that filter clogging has occurred due to dust. When it is determined that “filter wax-clogging” has occurred, the control portion outputs a command to the decompression valve 13 to be open (S3). Accordingly, the decompression valve 13 opens, and high-pressure fuel is introduced into the high-pressure pipe 20 from the common rail 4.

If a fuel pressure in the high-pressure pipe 20 is higher than a valve opening pressure of the check valve 25, the check valve 25 opens, and high-pressure fuel flows toward the circulation flow valve 26. When a temperature of fuel in the filter 6 is lower than a predetermined temperature, the circulation flow valve 26 is in an open state. When the circulation fuel valve 26 is open, high-pressure fuel is drawn into the filter 6. The high-pressure fuel dissolves wax adhering to the filter element 18, and is drawn to the fuel supply pump 3.

When the circulation flow valve 26 is closed, and when the decompression valve 13 opens due to the pressure in the common rail 4 higher than a predetermined value (e.g., in a case where the decompression valve 13 is used for pressure adjustment in the common rail 4), fuel of the common rail 4 returns to the fuel tank 2 through the high-pressure pipe 20, the return pipe 31 and the low-pressure pipe 12 (see, a broken arrow in FIG. 2).

Operation and effects of the present embodiment will be described below. The fuel injection device 1 of the present embodiment includes the high-pressure pipe 20 as the example of the circulation flow passage for introducing a part of high-pressure fuel into the filter 6 from the high-pressure flow passage, that is provided between the fuel supply pump 3 and the injector 5. The check valve 25 and the circulation flow valve 26 are arranged in this order from the upstream side in the high-pressure pipe 20.

Thus, the check valve 25 exists on a route through which high-pressure fuel is introduced into the filter 6. Hence, if the valve opening pressure in the check valve 25 is set to be relatively high, fuel of the high-pressure pipe 20 can be introduced into the filter 6 with the pressure of fuel of the high-pressure pipe 20 kept high. Therefore, fuel can be introduced into the filter 6 in a high-temperature state, and the filter wax-clogging can be dissolved securely.

In the present embodiment, the circulation flow valve 26, the check valve 25 and the filter 6 are unitized to configure the filter unit 28.

A pressure of high-pressure fuel in the circulation flow passage is released by the check valve 25. Because the circulation flow valve 26, the check valve 25 and the filter 6 are integrated, the pressure of high-pressure fuel can be released immediately before the fuel flows into the inlet 22 of the filter 6. A temperature of fuel becomes high due to friction between fuels at a pressure release position. Thus, by releasing a pressure at a position near the filter 6, fuel can be introduced into the filter 6 in a high-temperature state. Therefore, the filter wax-clogging can be dissolved surely.

The circulation valve 26 is the thermostatic valve, and is opened and closed due to a bimetal which deforms depending on a temperature. Accordingly, the circulation flow valve 26 can be formed in low cost and simply as compared to a case where the circulation flow valve 26 is an electromagnetic valve.

Modification of the above embodiment will be described below. In the fuel injection device 1 of the above embodiment, the example of the circulation flow passage, through which high-pressure fuel flows back to the filter 6, is the high-pressure pipe 20, which is opened and closed by the operation of the decompression valve 13 of the common rail 4. However, the circulation flow passage for introducing a part of high-pressure fuel into the filter 6 is not limited to this example. A flow passage, through which high-pressure fuel can flow back from the high-pressure flow passage provided between the fuel supply pump 3 and the injector 5 to the filter 6, may be used as the circulation flow passage.

In the present embodiment, a wax clogging of the filter 6 is determined based on the outside air temperature and the pressure at the downstream side of the filter 6. However, the temperature state of the engine may not be the outside air temperature, and may be, for example, a detection value from a temperature sensor attached to the fuel injection device or the engine. Moreover, the fuel pressure state around the filter 6 or in the filter 6 may not be the pressure at the downstream side of the filter 6, and may be a pressure change around the filter 6, such as a pressure change in the filter 6, and a pressure change at an upstream side of the filter 6, which is caused due to clogging of the filter 6.

In the present embodiment, the circulation flow valve 26, the check valve 25 and the filter 6 are unitized. However, the circulation flow valve 26, the check valve 25 and the filter 6 may be provided respectively separately. In this case, from a viewpoint in which fuel is kept in a high-temperature state, it is preferable that distances between the filter 6, the circulation flow valve 26 and the check valve 25 is made to be short. A valve lift amount in opening of the check valve 25 may be reduced as much as possible, so that a fuel passage is narrowed. Accordingly, frictional heat between passing fuel and a wall surface of the fuel passage can be generated effectively, and fuel can be in a further high-temperature state.

The fuel injection device 1 of the present embodiment injects and supplies fuel to a diesel engine, but can be applied to a device which injects and supplies fuel to a gasoline engine.

Additional advantages and modifications will readily occur to those skilled in the art. The invention in its broader terms is therefore not limited to the specific details, representative apparatus, and illustrative examples shown and described.

What is claimed is:

1. A fuel injection device comprising:
a fuel supply pump which pressurizes and discharges fuel;
an injector which injects and supplies fuel discharged from the fuel supply pump, to an engine;
a filter arranged upstream of the fuel supply pump to remove foreign material contained in fuel;
a circulation flow passage configured to introduce high-pressure fuel into the filter from a high-pressure flow passage provided between the fuel supply pump and the injector;
an introduction valve configured to allow or interrupt inflow of high-pressure fuel from the high-pressure flow passage into the circulation flow passage;
a circulation flow valve that is provided in the circulation flow passage and is opened or closed depending on a temperature of fuel to allow or interrupt inflow of fuel from the circulation flow passage into the filter; and
a check valve provided upstream of the circulation flow valve in the circulation flow passage to prevent backflow, wherein the check valve opens when a pressure of fuel in the circulation flow passage is higher than a predetermined pressure.

2. The fuel injection device according to claim 1, wherein the circulation flow valve and the check valve are integrated with the filter.

3. The fuel injection device according to claim 1, further comprising:
a determination portion configured to determine whether the filter is clogged with wax, based on a fuel pressure state in the filter or around the filter and based on a temperature state of the engine; and
a control portion configured to command the introduction valve to introduce high-pressure fuel into the circulation flow passage when the filter is clogged with wax.

4. The fuel injection device according to claim 1, further comprising
a common rail provided between the fuel supply pump and the injector to store fuel supplied from the fuel supply pump, wherein
the common rail is connected to an inlet of the filter through the circulation flow passage,
the introduction valve is used as a pressure control valve configured to control a pressure of fuel in the common rail, and
the pressure control valve causes high-pressure fuel in the common rail to be introduced into the circulation flow passage by opening of the pressure control valve.

5. The fuel injection device according to claim 1, wherein the circulation flow valve is opened and closed due to a bimetal which deforms depending on a temperature.
